(19) United States
(12) Patent Application Publication
(10) Pub. No.: US 2022/0220621 A1
(43) Pub. Date: Jul. 14, 2022

(54) METHOD AND SYSTEM FOR AN OFF-GRID VARIABLE STATE HYDROGEN REFUELING INFRASTRUCTURE

(71) Applicant: Alakai Technologies Corporation, Stow, MA (US)

(72) Inventors: Brian D. Morrison, Hopkinton, MA (US); William Spellane, Worcester, MA (US); Glenn Austin, Marlborough, MA (US)

(21) Appl. No.: 17/568,490

(22) Filed: Jan. 4, 2022

Related U.S. Application Data
(60) Provisional application No. 63/135,226, filed on Jan. 8, 2021.

(51) Int. Cl. C25B 1/04; C25B 15/08; C25B 15/023; C25B 13/08; B64F 1/28; B64D 37/02

(52) U.S. Cl. CPC C25B 1/04; C25B 15/08; B64D 37/02; C25B 13/08; B64F 1/28; C25B 15/023

(57) ABSTRACT

A method, system, and apparatus for managing variable, multi-phase on-site electric power and fluid conversion to output fuel and energy for providing customizable management for processing hydrogen-based fuels. In particular, the method, system and apparatus provide for automated feedback and control, directing inputs for conversion including electrolysis to create fuel products including gaseous hydrogen and liquid hydrogen to be used in clean-fuel vehicles onsite or transported to be used for vehicle delivery, according to settings or system parameters to meet demand quickly and efficiently for various products while making adjustments in real time.

### CROSS-REFERENCE TO RELATED APPLICATION(S)

This application claims priority to, and the benefit of, co-pending U.S. Provisional Application 63/135,226, filed Jan. 8, 2021, for all subject matter common to both applications. The disclosure of said provisional application is hereby incorporated by reference in its entirety.

### FIELD OF THE INVENTION

The present invention relates to a method, system, and apparatus for managing a variable, single, or multi-phase on-site electric power and fuel production infrastructure to utilize electrical grid or off-grid power (from traditional grid sources as well as the so-called green sources such as solar, wind, geothermal, hydroelectric, tidal, or other sources) to generate or create hydrogen energy (in gaseous and/or liquid form) and electrical energy for providing customizable management for processing hydrogen-based fuels. In particular, the method, system, and apparatus provide for automated feedback and control for generation and conversion operations including electrolysis to create fuel products including gaseous hydrogen and liquid hydrogen to be used in clean-fuel vehicles onsite or transported to be used for vehicle-based fuel delivery, according to settings or system parameters and conditions adjusted in real-time to meet the demand quickly and efficiently for various products.

### BACKGROUND

Generally, an infrastructure for locally produced hydrogen production and supply for use in clean-fuel applications has not been widely adopted, in part due to the monopoly of several large industrial hydrogen suppliers. Various methods of producing usable hydrogen exist, and many industrial applications currently produce hydrogen from natural gas through a steam reforming process. Most of the hydrogen is therefore produced from hydrocarbons, and as a result, such fuel contains trace amounts of carbon monoxide among other impurities that are unattractive for expanded use in fuels for environmental protection reasons. Moreover, carbon monoxide and other impurities can be detrimental to various systems including many fuel cells that make it impractical to adopt as part of a fuel infrastructure for clean-fuel vehicles based on fuel cells and similar technologies. In addition, a carbon-neutral method of hydrogen production is desired that does not produce carbon bi-products. Currently available and utilized hydrogen fuel cells require near pipeline quality hydrogen gas in order to function optimally. Alternative hydrogen production technologies including electrolysis offer superior alternatives but until recently were less feasible due to production costs, and so often hydrogen was intentionally produced from electrolysis only for specific point of use applications, such as when extremely high purity hydrogen or oxygen was desired.

Many industrial electrolysis cells have made improvements in efficiency and cost-effectiveness and have adopted one of two leading processes in this industry that use either alkaline or proton exchange membrane (PEM) electrolyzers. Alkaline electrolyzers are cheaper in terms of investment, but less efficient. Both processes are energy intensive and typically require onsite electrical power generation. Thus, the supply of hydrogen in remote areas with insufficient infrastructure presents a challenge. Existing systems are not sufficient to meet the need for more compact, modular, and flexible systems (that are both scalable and operable with a variety of types of inputs and outputs) for hydrogen production that do not rely on grid electricity production so as to meaningfully improve hydrogen supply infrastructure for applications including clean-fuel vehicles. Disaster management and recovery operations also provide a key application area where clean-fuel vehicles are preferred and this type of implementation of these vehicles often requires mobile or modular fueling and refueling infrastructure that are operable free from compromised, damaged, or unavailable electrical power grid components or over-the-road delivery.

Additionally, many existing infrastructure systems can only produce a single fuel type. This means vehicles or equipment using liquid hydrogen as fuel cannot be serviced at the same facility as vehicles using gaseous hydrogen as fuel. This leads to limited utility to a significant portion of hydrogen fuel applications and thus impedes further development of a larger scale and scope for hydrogen infrastructure. Additionally, bottlenecks and delays as well as insufficient processing losing portions of gas or liquid fuel due to friction, leakage, heat loss and other system inefficiencies make existing systems and methods that generate hydrogen at central locations and distribute it extensively over long transport distances unattractive alternatives for many parties seeking effective fuel supply and conversion to other usable resources. This is in part because, unlike fossil fuels, hydrogen infrastructure need not rely on such transport over long distances because the resources are far more abundant and readily available through a variety of retrieval and production techniques (including those already described). On-site production limits these transport delays and obstructions to transport and delivery.

In short, current hydrogen fuel production technologies lack sufficient ability to adjust to a variety of associated parameters, are too inefficient in the manner they process those gases and liquids and possess limitations that result in the needless waste of an extensive amount of components or constituents of those fuels that could be put to more productive use while reducing negative environmental consequences.

### SUMMARY

There is a need for variable fluid conversion to output fuel and energy for providing customizable management for processing a volume of hydrogen that may be selectively conditioned, separated, and blended into a variety of different products that more efficiently uses available resources to fuel onsite applications in a responsive and dynamic manner that adapts to changing fuel demands and changing hydrogen content. There is a need for compact, modular, and flexible systems (that are both scalable and operable with a variety of types of inputs and outputs) for hydrogen production that do not rely on grid electricity production to meaningfully improve hydrogen supply infrastructure for applications including clean-fuel vehicles. The present invention is directed toward further solutions to address these needs, in addition to having other desirable characteristics. In particular, the method, system, and apparatus of the present invention provide for managing variable, multi-phase on-site electric power and fluid conversion to output fuel and energy for providing customizable management for processing hydrogen-based fuels. Specifically, the present invention relates to a method, system and apparatus provide for self-contained, automated feedback and control, directing inputs for conversion processes including electrolysis to create fuel products including gaseous hydrogen and liquid hydrogen to be used in clean-fuel vehicles onsite or transported to be used for vehicle fuel delivery services or combined into other applications, according to settings or system parameters to quickly and efficiently meet the demand for various products while making adjustments in real-time for managing variable, multi-phase fluid conversion.

The method, system, and apparatus of the present invention automatically adjust to varying inputs—rerouting products, intermediate products and by-products based on demand, operating conditions, and input composition. It adjusts system flows to the correct configuration and continues processing to provide products, including electrical power to onsite systems, without reductions in capacity or bottlenecks associated with keeping certain components operating within parameters, thereby freeing more power to be transmitted and more fuel products to be delivered. In example embodiments, more or less flow can be allocated to various subprocesses, converted and/or diverted to hydrogen gas or hydrogen liquid conduits or wastegates for additional value-added products for multifuel applications or transportation for external use in addition to power and fuel generation occurring on site. Quality and range of products are improved while fuel supply and/or flow demand do not suffer bottlenecks or reduced capacity due to system flexibility and active management.

In accordance with embodiments of the present invention, a method of operating an off-grid variable-state hydrogen refueling infrastructure includes a local energy source generating electrical power. A fluid supply subsystem receives input water from a water source. A fluid conditioning subsystem converts the input water into a conditioned electrolyte. An electrolyzer applies generated electrical power to the conditioned electrolyte to produce gaseous hydrogen (GH₂) by electrolysis. A product subsystem collects the gaseous hydrogen (GH₂) and stores it in one or more storage vessels or converts the gaseous hydrogen (GH₂) into liquid hydrogen (LH₂) through refrigeration and stores the liquid hydrogen (LH₂) in one or more liquid storage vessels. A monitoring and control subsystem dynamically controls the production of gaseous hydrogen (GH₂) or liquid hydrogen (LH₂). A dispensing subsystem delivers the gaseous hydrogen (GH₂) or liquid hydrogen (LH₂) from storage vessels to one or more refueling destinations.

In accordance with aspects of the present invention, the local energy source can include one or more windmills or wind turbines, solar arrays, hydroelectric reservoirs or turbines, geothermal systems biomass reactors or digestors, tidal generators, nuclear generators, or natural gas processing units or turbines. The water source of the fluid supply subsystem can include one or more of a natural or man-made body of water, a municipal water supply, a water utility, a water treatment plant, a storm drainage system, an H2O pipeline, a precipitation storage reservoir or cistern, a water reclamation system, a well or groundwater.

In accordance with aspects of the present invention, the fluid supply subsystem converting the input water into conditioned electrolyte can include treating the water source by adjusting the salinity of the input water. Converting gaseous hydrogen (GH₂) to liquid hydrogen (LH₂) can be performed by a liquefier or specialized chiller or refrigerator.

In accordance with aspects of the present invention, the monitoring and control subsystem can include one or more sensors; one or more production controls; and at least one processor controlling the one or more production controls based on input from one or more sensors. The dispensing subsystem can include one or more pump dispensers for delivering gaseous hydrogen (GH₂) or liquid hydrogen (LH₂).

In accordance with aspects of the present invention, the refueling destination can include a fuel tank of a clean-fuel electric vehicle stationed at a designated refueling zone serviced by the dispensing subsystem. The refueling destination can include a tanker stationed at a designated refueling zone serviced by the dispensing subsystem. The tanker can transport the gaseous hydrogen (GH₂) or liquid hydrogen (LH₂) to a clean-fuel electric vehicle stationed at a user location designated for remote refueling service. The tanker can transport one or more modular, refillable GH2 or LH2 tanks that can be interchanged with an empty container at the refueling site or destination. The refueling destination can include an auxiliary fuel tank of a multirotor aircraft stationed at a designated refueling zone serviced by the dispensing subsystem. The multirotor aircraft can transport the gaseous hydrogen (GH₂) or liquid hydrogen (LH₂) to a clean-fuel electric vehicle stationed at a user location designated for remote refueling service.

In accordance with aspects of the present invention, the one or more storage vessels or one or more liquid storage vessels can include one or more of insulated tanks, compressed gas tanks, mobile tanks, cryogenic tanks, or tanker trucks. The electrolyzer can be a polymer electrolyte membrane (PEM) electrolysis.

In accordance with aspects of the present invention, dynamically controlling production of gaseous hydrogen (GH₂) or liquid hydrogen (LH₂) can include one or more of: increasing or decreasing flow of input water to the fluid supply subsystem; increasing or decreasing power generated from the local energy source; increasing or decreasing production and flow of conditioned electrolyte from the fluid conditioning subsystem to the electrolyzer; increasing or decreasing a rate of electrolysis in the electrolyzer producing gaseous hydrogen (GH2); increasing or decreasing flow of gaseous hydrogen GH2 from the electrolyzer to one or more of: one or more storage vessels, a liquefier or a compressor; increasing or decreasing flow of liquid hydrogen LH2, to one or more liquid storage vessels; increasing or decreasing flow of GH2 or LH2 from the one or more storage vessels or one or more liquid storage vessels to the dispensing subsystem; and increasing or decreasing flow of GH2 or LH2 to a refueling destination.

In accordance with aspects of the present invention, the method can further include a selectably activated alternative connection to an electrical grid configured to supply selectively off-peak excess grid electricity for conversion into LH2 or GH2 that is stored for later consumption using the one or more storage vessels or one or more liquid storage vessels.

In accordance with embodiments of the present invention, an off-grid variable-state hydrogen refueling system infrastructure includes a local energy source generating electrical power. A fluid supply subsystem receives input water from a water source. A fluid conditioning subsystem, in fluid communication with the fluid supply subsystem, is configured to convert the input water into a conditioned electrolyte. An electrolyzer, in electrical communication with the local energy source and fluid communication with the fluid conditioning subsystem, is configured to apply generated electrical power to the conditioned electrolyte to produce gaseous hydrogen (GH₂) by electrolysis. A product subsystem, in fluid communication with the electrolyzer, is configured to collect the gaseous hydrogen (GH₂) and store it in one or more storage vessels or convert the gaseous hydrogen (GH₂) into liquid hydrogen (LH₂) and store the liquid hydrogen (LH₂) in one or more liquid storage vessels. A monitoring and control subsystem is configured dynamically controlling the production of gaseous hydrogen (GH₂) or liquid hydrogen (LH₂). A dispensing subsystem, in fluid communication with the product subsystem, is configured to deliver the gaseous hydrogen (GH₂) or liquid hydrogen (LH₂) from storage containers to one or more refueling destinations.

In accordance with aspects of the present invention, the local energy source can include one or more windmills or wind turbines, solar arrays, hydroelectric reservoirs or turbines, geothermal systems, biomass reactors or digestors, tidal generators, nuclear generators, or natural gas processing units or turbines. The water source of the fluid supply subsystem can include one or more of a natural or man-made body of water, a municipal water supply, a water utility, a water treatment plant, a storm drainage system, an H2O pipeline, a precipitation storage reservoir, or cistern, a water reclamation system, a well or groundwater. The fluid supply subsystem can convert the input water into a conditioned electrolyte by treating the water source by adjusting the salinity of the input water. Converting gaseous hydrogen (GH₂) to liquid hydrogen (LH₂) can be performed by a liquefier or specialized chiller or refrigerator.

In accordance with aspects of the present invention, the monitoring and control subsystem can include one or more sensors; one or more production controls; and at least one processor controlling the one or more production controls based on input from one or more sensors. The dispensing subsystem can include one or more pump dispensers for delivering gaseous hydrogen (GH₂) or liquid hydrogen (LH₂). The refueling destination can include a fuel tank of a clean-fuel electric vehicle stationed at a designated refueling zone serviced by the dispensing subsystem. The refueling destination can include a tanker stationed at a designated refueling zone serviced by the dispensing subsystem. The tanker can transport the gaseous hydrogen (GH₂) or liquid hydrogen (LH₂) to a clean-fuel electric vehicle stationed at a user location designated for remote refueling service. The refueling destination can include an auxiliary fuel tank or modular tank element of a multirotor aircraft stationed at a designated refueling zone serviced by the dispensing subsystem. The multirotor aircraft transports the gaseous hydrogen (GH₂) or liquid hydrogen (LH₂) to a clean-fuel electric vehicle stationed at a user location designated for remote refueling service. The one or more storage vessels or one or more liquid storage vessels can include one or more of insulated tanks, compressed gas tanks, mobile tanks, cryogenic tanks, or tanker trucks. The electrolyzer can be a polymer electrolyte membrane (PEM) electrolysis.

In accordance with aspects of the present invention, dynamically controlling production of gaseous hydrogen (GH₂) or liquid hydrogen (LH₂) can include one or more of: increasing or decreasing flow of input water to the fluid supply subsystem; increasing or decreasing power generated from the local energy source; increasing or decreasing production and flow of conditioned electrolyte from the fluid conditioning subsystem to the electrolyzer; increasing or decreasing a rate of electrolysis in the electrolyzer producing gaseous hydrogen (GH2); increasing or decreasing flow of gaseous hydrogen GH2 from the electrolyzer to one or more of: one or more storage vessels, a liquefier or a compressor; increasing or decreasing flow of liquid hydrogen LH2, to one or more liquid storage vessels; increasing or decreasing flow of GH2 or LH2 from the one or more storage vessels or one or more liquid storage vessels to the dispensing subsystem; and increasing or decreasing flow of GH2 or LH2 to a refueling destination.

In accordance with aspects of the present invention, the system can further include a selectably activated alternative connection to an electrical grid configured to supply selectively off-peak excess grid electricity for conversion into LH2 or GH2 that is stored for later consumption using the one or more storage vessels or one or more liquid storage vessels.

Those of skill in the art will understand that the system is capable of scaling, including by configuring subsystems and components to comprise a greater number of sets or alternative configurations for managing and routing fuel products, as well as a greater number of intermediate steps, stages or products created as fuel is converted and transported through the system during processing. The system is modular, scalable and may be constructed at or transported to remote locations. This on-demand system produces fuel of different types as required or demanded by the particular applications.

### BRIEF DESCRIPTION OF THE FIGURES

These and other characteristics of the present invention will be more fully understood by reference to the following detailed description in conjunction with the attached drawings, in which:

FIG. 1 is an example illustrative diagram of an alternative embodiment of the present invention converting input electricity into multiple different gas compositions and products;

FIG. 2. is an example illustrative diagram of storage vessel components;

FIG. 3 is an example illustrative diagram of a computer device used in the present invention and

FIG. 4 is an example illustrative diagram of an alternative embodiment of the present invention that provides on-site refueling;

FIG. 5 is another example illustrative diagram of an alternative embodiment of the present invention that provides on-site refueling;

FIG. 6 is an example illustrative diagram of refueling destination locations; and

FIG. 7. is an example illustrative flowchart of the system and method.

### DETAILED DESCRIPTION

An illustrative embodiment of the present invention relates to a method, system, and apparatus for managing variable, multi-phase on-site electric power and fluid conversion to output fuel and energy for providing customizable management for generating and processing hydrogen-based fuels in a hydrogen infrastructure. In particular, the method, system, and apparatus provide for automated feedback and control directing various inputs and process constituents to different subsystems, components according to settings or system parameters in order to create fuel products (by processes including electrolysis) including gaseous hydrogen and liquid hydrogen to be used in clean-fuel vehicles onsite or transported to be used for vehicle delivery to quickly and efficiently meet demand for various fuel products while making adjustments in real-time to create a compact, self-contained facility for hydrogen fuel infrastructure applications.

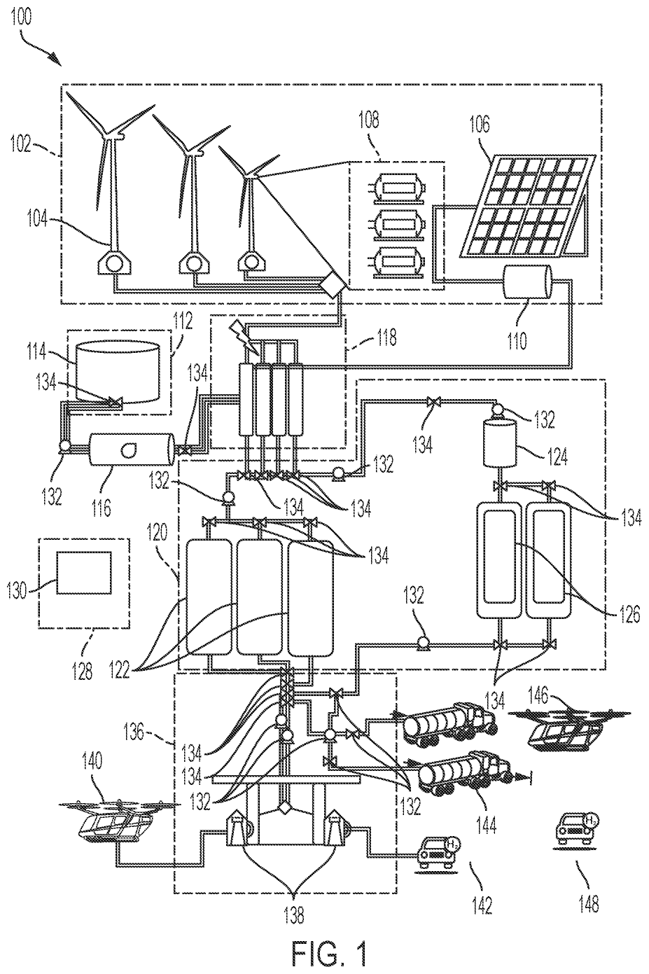

FIGS. 1 through 7, wherein like parts are designated by like reference numerals throughout, illustrate an example embodiment or embodiments of multi-phase on-site, off-grid electric power and fluid conversion method, system, and apparatus for providing customizable management for generating, processing, and outputting hydrogen-based fuels or stored energy, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention.

Referring now to FIG. 1, one example embodiment of the present invention includes an off-grid, modular, multi-fuel production and conversion system 100 with independent subsystems, components, assemblies, or modules that are interconnected fluidly and/or electrically (for power transmission; measured data collection, analysis, and transmission, control signal transmission, etc.) to act as one unit to process on-site generated electricity into one or more types or phases of hydrogen-based fuel as part of a hydrogen fuel infrastructure. The system 100, with the on-site electricity generating equipment and subsystems as well as a fluid stream input from, e.g., a water source, is capable of being scaled or sized to an end user's needs that may include but is not limited to, a combination of a compressor or liquefier, storage vessels or tanks of multiple types, and one or more fuel product transport conduits, pipelines or outlets. A computerized monitoring and control subsystem provides closed-loop control networks to monitor, meter, and control input flows (generated electricity, electrolytes, etc.), water flow, electrical power distribution, and fuel product flow, as well as other system parameters.

FIG. 1 illustrates example embodiments of the present invention including a fuel production system 100 comprising components adapted from commercially available equipment or custom designed facilitates fully integrated with system 100 and related systems such as software and controls. As such, the system 100 functions as a single fuel production system 100 which receives input fluid and on-site generated electricity and converts it to a product fuel of gaseous hydrogen (GH₂), which can be converted to adjust certain gas properties including, but not limited to, compressing the gas through increased pressure to convert it into the form of liquid/liquefied hydrogen (LH₂).

The system 100 includes a local energy source 102, a fluid supply subsystem 112, a fluid conditioning subsystem 116, an electrolyzer 118, a product subsystem 120, a monitoring and control subsystem 128, and a dispensing subsystem 136.

The off the grid, on-site, local energy source 102 is configured to generate power. The local energy source 102 is configured to derive solar, mechanical (including wind), geothermal, potential, tidal, or other types of energy known in the art to be used to power on-site electricity generation. This local energy source 102 may be any form of on-site or nearby electrical generation plant or device, including hydro-electric, solar, wind, geothermal, biomass reactors or digestors, natural gas, turbines, tidal, nuclear, and other methods for generating electricity known in the art. In the example of FIG. 1, these include windmills 104 and solar cells 106 or arrays. In the case of a mechanical system, such as windmill 104, the local energy source includes at least one generator 108 which then provides power to the various components and subsystems of the system 100.

The local energy source 102 may also include batteries or capacitors 110 storing generated electricity in excess of what is required. There may be periods, such as when maintenance or repairs are being performed on components of the system, when downstream subsystems do not require full production from the electricity generating subsystem and the generated electricity can be stored for use or consumption at later periods, such as when the electricity-generating subsystem itself is required to perform maintenance or repairs or must otherwise be offline. In other instances where sudden extreme demand for fuel that outpaces the production capacity of the electricity generating subsystem may still be met by drawing from stored electricity as well as newly generated electrical from the local energy source 102. In this way, production is made more flexible to meet variable demand for fuel products. One of skill in the art will appreciate that different components or subsystems of the system 100 may at different times become bottlenecks in the overall production process based on changing operating conditions (internal and/or external in origin) and it is advantageous for this variable capacity and capability to adapt to the changing operating conditions and smooth out production of hydrogen fuels and otherwise adjust to meet variable demands for various fuel products over time. In an example embodiment, as power production increases or decreases the system can accordingly increase or decrease fuel production based on changes in at least one of several parameters (e.g., supplied voltage/current, pressure, and/or flow rate).

In an example embodiment, the fuel production system 100 further includes a fluid supply subsystem 112 to provide input fluids including input water for use in hydrogen production. The location of the system 100 also connects a fluid source 114, including e.g., a water source, to the system 100 that supplies the system 100 with input water or other fluid by e.g., pipes or other fluid conduits that have connections and junctions known in the art in order to be in fluid communication with the fluid conditioning subsystem 116 of the system. The water or fluid source 114 may be a connection to a local or municipal water provider, treatment plant, or utility, or it may be part of an onsite water collection subsystem, such as a well, a reservoir, groundwater, storm drainage system, a natural or man-made body of water used to provide hydroelectric power, rainwater, precipitation, or condensation collection or reclamation subsystem including a cistern, a water tanker truck or external water tank, a greywater management subsystem operated at the location of the fluid supply subsystem 112 of the system 100, or other components known in the art.

The fluid conditioning subsystem 116 receives input water or other fluid from the fluid supply subsystem 112 that may be used as an electrolyte and then processes it to meet system 100 specifications for input into the electrolyzer 118. In the example embodiment, the fluid conditioning subsystem 116 is in fluid communication with the fluid supply subsystem 112, and incoming input water is treated to become an electrolyte that meets system specifications. This may include filtering water (or other fluids) or otherwise removing unwanted constituents or contaminants that adversely influence performance as an electrolyzer 118. There are a number of filtering and purifying techniques known in the art that may be used (filters, osmosis, distillation, etc.) to adjust the characteristics of the input water or other fluid to meet system 100 specifications. In some example embodiments, mixing components add or remove salt to adjust the salinity of the input water to create a suitable electrolyte, where the reactions comprising electrolysis are known to perform better with saltwater. In other embodiments, the system 100 may employ solid polymer electrolytes such that input water need not be treated to the same level of salinity to be applied to the electrolysis process and fuel generation processes. Common salts added or used by the fluid conditioning subsystem 116 to create a suitable electrolyte include but are not limited to, sodium chloride. Other compounds may be used to create a suitable electrolyte that meets system 100 parameters, as understood by one of skill in the art.

In an example embodiment, the fuel production system 100 further includes an electrolyzer 118 to convert electricity and electrolyte such as water into hydrogen and oxygen (or similar reaction products known in the art). The electrolyzer 118 is in fluid communication with the fluid conditioning subsystem 116 and electrical communication with the local energy source. The electrolyzer 118 receives the conditioned electrolyte in a vessel configured with electrodes, electrical connections or other similar means known in the art disposed therein to transmit electrical voltage and current to the electrolyte to develop hydrogen. The electrolysis performed within the electrolyzer 118 may be one of several types, for which the electrolyzer 118 is particularly configured to perform. For example, Polymer electrolyte membrane (PEM) electrolysis is the electrolysis of water in a cell equipped with a solid polymer electrolyte (SPE) that performs conduction of protons (to conduct protons from the anode to the cathode), separation of product gases, and includes electrical insulation of electrodes. The PEM type electrolyzer 118 overcomes issues of partial load, low current density, and low-pressure operation currently that present difficulties in other types of electrolyzer 118 including alkaline electrolyzers 118. It may further include specifically a proton-exchange membrane. The solid structure of the polymer electrolyte membrane exhibits a low gas crossover rate resulting in very high product gas purity. The PEM electrolyzers 118 can operate under highly dynamic conditions as a buffer or a means of storing off-peak energy that are advantageous for off-grid and on-site energy production (and subsequent conversion to fuel products). In an alternative embodiment, alkaline electrolyzers 118 may instead be employed that require water in liquid form and use alkalinity to facilitate the breaking of the bond holding the hydrogen and oxygen atoms together. In another alternative embodiment, an electrolyzer 118 may generally comprise electrodes or a catalyst to apply a voltage to the electrolyte solution to create the reaction generating or liberating hydrogen gas, as understood by one of ordinary skill in the art.

Generally, in an electrolyzer 118, electrolysis is performed wherein an anode side half reaction takes place on the anode side of e.g., a PEM electrolyzer 118 and is commonly referred to as the Oxygen Evolution Reaction (OER). Here the liquid water reactant is supplied to catalyst where the supplied water is oxidized to oxygen, protons and electrons following one of these known equations:

H₂O(l)-->O₂(g)+4H⁺(aq)+4e⁻ or H₂O-->½O₂(g)+2H⁺(aq)+2e⁻

Similarly, in an electrolyzer 118, the cathode side half reaction taking place on the cathode side of e.g., a PEM electrolyzer 118 is commonly referred to as the Hydrogen Evolution Reaction (HER). Here the supplied electrons and the protons that have conducted through the membrane are combined to create gaseous hydrogen following one of these known equations:

4H+(aq)+4e⁻-->2H₂(g) or 2H+(aq)+2e⁻-->H₂(g)

Generally, the electrolysis performed in an electrolyzer 118 uses water as an electrolyte coupled with electricity and often specific heat or thermodynamic input to generate hydrogen and byproduct oxygen, taking the form of the following equation:

H₂O(l){electricity}/{heat}-->H₂(g)+½O₂

In an example embodiment, the hydrogen generated by the electrolyzer 118 and other products of the electrolysis reactions are received by and managed by a product subsystem 120. The product subsystem 120 collects the e.g., H₂ (Hydrogen as a fuel but also used as a working fluid) generated by the process at the electrolyzer 118 in fluid communication with the product subsystem 120. The product subsystem 120 directs the flow of a stream of hydrogen-based on operating parameters and operating conditions, so as to direct the flow to one or more of storage as hydrogen gas (GH₂) in the one or more liquid storage vessels 122, additional processing in a condenser, refrigerator, specialized chiller, or liquefier 124 to produce hydrogen fuel in a liquid phase (LH₂ by pressure adjustment or temperature adjustment made to the flow stream and using various additional Liquid Hydrogen Storage components of the subsystem as required) and stored in one or more storage vessel 126, or immediate dispensing through the dispensing subsystem 136 to meet an immediate demand for gaseous or liquid hydrogen fuel.

The appropriate directing of the fuel to these various destinations is controlled by the monitoring and control subsystem 128 which monitors and controls the pressure, volume, temperature etc. of the flow of the gaseous and liquid hydrogen and the pressure, volume, temperature etc. of the hydrogen fuel already present in each of these destination locations using sensors 132 and controls 134, including sensors 132 and controls 134 embedded within the pipes, couplings, fluid conduits, connectors, and junctions of the product subsystem 120. Fluid streams, including fuel products, are moved by a series of one or more pumps and/or compressors.

The monitoring and control subsystem 128 dynamically controls the production of gaseous hydrogen (GH₂) and/or liquid hydrogen (LH₂). In certain embodiments, the monitoring and control subsystem 128 include one or more sensors 132, one or more production controls 134, and at least one processor 130 controlling the one or more production controls 134 based on input from one or more sensors. As seen in the example of FIG. 1, the sensors 132 and controls 134 are situated throughout the system 100 and can be found in the various subsystems including the local energy source 102, fluid supply subsystem 112, fluid conditioning subsystem 116, electrolyzer 118, product subsystem 120, and dispensing subsystem 136. The sensors 132 and controls 134 are in communication with at least one processor 130 with the sensors 132 providing the status of the various subsystems including, but not limited to: pressure, volume, temperature, power levels, and status; and the controls 134 including valves, regulators, switches, and other electrical and/or mechanical control mechanisms, allowing for the control of the various subsystems based on the status provided by the sensors 132.

In an example embodiment, the fuel production system 100 further includes a dispensing subsystem 136 delivering the gaseous hydrogen (GH₂) or liquid hydrogen (LH₂) from one or more storage vessels 122/126 to a refueling destination. In certain embodiments, the dispensing subsystem 136 comprises one or more dispensing pumps 138 for delivering gaseous hydrogen (GH₂) or liquid hydrogen (LH₂). In some embodiments, the refueling destination comprises a fuel tank of a clean-fuel electric vehicle, such as multirotor aircraft 140 or automobile 142 stationed at a designated refueling zone serviced by the dispensing subsystem 136.

In other embodiments, wherein the refueling destination comprises a tanker 144, which may also be a clean-fuel electric vehicle, stationed at a designated refueling zone serviced by the dispensing subsystem 136. In some such other embodiments, the tanker 144 may then transport the gaseous hydrogen (GH₂) or liquid hydrogen (LH₂) to a clean-fuel electric vehicle, such as a multirotor aircraft 146 or automobile 148, stationed at a user location designated for remote refueling service. In still other embodiments, the refueling destination comprises an auxiliary fuel tank of a multirotor aircraft 140 stationed at a designated refueling zone serviced by the dispensing subsystem. In some such embodiments, the multirotor aircraft 140 may then transport the gaseous hydrogen (GH₂) to liquid hydrogen (LH₂) a clean-fuel electric vehicle, such as a multirotor aircraft 146 or automobile 148, stationed at a user location designated for remote refueling service.

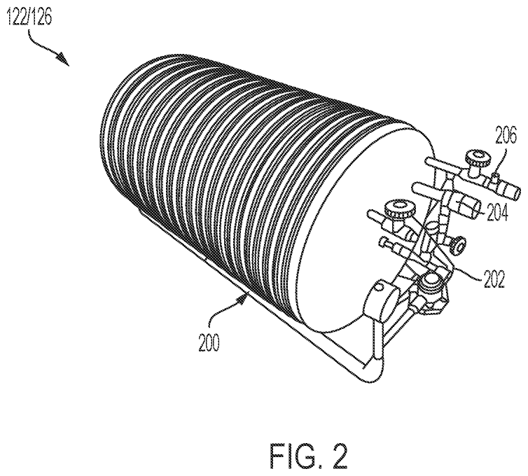

FIG. 2 depicts an example illustrative diagram of storage vessel components and subcomponents including one or more storage vessels 122, one or more liquid storage vessels 126 of the product subsystem 120 that may include various types of fuel tanks, portable tanks, or movable tankers. The one or more storage vessels 122 or one or more liquid storage vessels 126 may comprise one or more of insulated tanks, compressed gas tanks, mobile tanks, cryogenic tanks, or tanker trucks. These may further comprise a shell 200 such as a carbon fiber epoxy shell or stainless steel or other robust shell, plastic, or metallic liner, a metal interface, crash/drop protection, and is configured to use a working fluid of hydrogen as the fuel with fuel lines, vessels and piping designed to the ASME Code and DOT Codes for the pressure and temperatures involved. Generally, in a thermodynamic system, the working fluid is a liquid or gas that absorbs or transmits energy or actuates a machine or heat engine. In this invention, working fluids may include fuel in a liquid or gaseous state, coolant, pressurized or other air that may or may not be heated. The one or more storage vessels 122 or one or more liquid storage vessels 126 may be designed to include venting to an external zone and comprises multiple valves and instruments for the operation of the vessels. In one embodiment vessels comprise mating parts including GH₂ or LH₂ ports (male or female part of a fuel transfer coupling); mating part B including a ⅜″B (VENT), ¼″(PT), ¼″(PG&PC), feed through, vacuum port, vacuum gauge, spare port, ¼″ sensor (Liquid detection); and mating part C including at least one 1-inch union as well as ½″ safety valves 202. The hydrogen storage subsystems and fuel tanks 122/126 may employ at least one a fuel transfer coupling 204 for charging; 1 bar vent 206 for charging; self-pressure build-up unit; at least two safety relief valves; GH₂ heating components; vessels and piping that routed to a heat exchanger or are otherwise in contact with fluid conduits for fuel cell coolant water. The fuel tank 122/126 may also include a level sensor (High Capacitance) and meet regulatory requirements. In another embodiment, an LH₂ fuel tank 122/126 may comprise one or more inner tanks, an insulating wrap, a vacuum between the inner and outer tank, and a much lower operating pressure, typically approximately 10 bar, or 140 psi (where GH₂ typically runs at much higher pressure). The smaller or portable vessels may also be equipped with at least one protection ring to provide further drop and crash protection for connectors, regulators, and similar components.

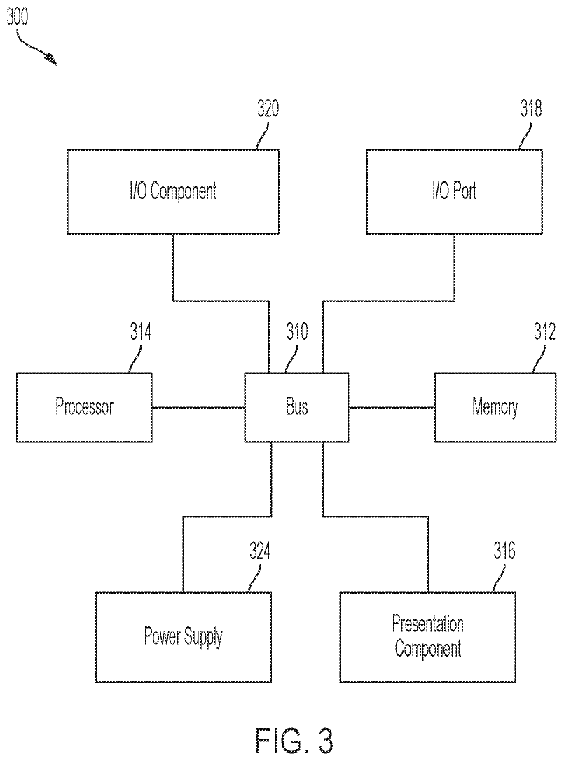

A computing device can be used to provide the functionality of the processor 130 and other components of the monitoring and control subsystem 128 to implement the system and methods/functionality described herein and be converted to a specific system for performing the operations and features described herein through modification of hardware, software, and firmware, in a manner significantly more than the mere execution of software on a generic computing device, as would be appreciated by those of skill in the art. One illustrative example of such a computing device 300 is depicted in FIG. 3. The computing device 500 is merely an illustrative example of a suitable computing environment and in no way limits the scope of the present invention. A “computing device,” as represented by FIG. 3, can include a “workstation,” a “server,” a “laptop,” a “desktop,” a “hand-held device,” a “mobile device,” a “tablet computer,” or other computing devices, as would be understood by those of skill in the art. Given that the computing device 300 is depicted for illustrative purposes, embodiments of the present invention may utilize any number of computing devices 300 in any number of different ways to implement a single embodiment of the present invention. Accordingly, embodiments of the present invention are not limited to a single computing device 300, as would be appreciated by one with skill in the art, nor are they limited to a single type of implementation or configuration of the example computing device 300.

The computing device 300 can include a bus 310 that can be coupled to one or more of the following illustrative components, directly or indirectly: a memory 312, one or more processors 314, one or more presentation components 316, input/output ports 318, input/output components 320, and a power supply 324. One of skill in the art will appreciate that the bus 310 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 3 is merely illustrative of an exemplary computing device that can be used to implement one or more embodiments of the present invention, and in no way limits the invention.

The computing device 300 can include or interact with a variety of computer-readable media. For example, computer-readable media can include Random Access Memory (RAM); Read-Only Memory (ROM); Electronically Erasable Programmable Read-Only Memory (EEPROM); flash memory or other memory technologies; CDROM, digital versatile disks (DVD), or other optical or holographic media; magnetic cassettes, magnetic tape, magnetic disk storage or other magnetic storage devices that can be used to encode information and can be accessed by the computing device 300.

The memory 312 can include computer-storage media in the form of volatile and/or nonvolatile memory. The memory 312 may be removable, non-removable, or any combination thereof. Exemplary hardware devices are devices such as hard drives, solid-state memory, optical-disc drives, and the like. The computing device 300 can include one or more processors that read data from components such as the memory 312, the various I/O components 316, etc. Presentation component(s) 316 present data indications to a user or other device. Exemplary presentation components include a display device, speaker, printing component, vibrating component, etc.

The I/O ports 318 can enable the computing device 300 to be logically coupled to other devices, such as I/O components 320. Some of the I/O components 320 can be built into the computing device 300. Examples of such I/O components 320 include a microphone, joystick, recording device, gamepad, satellite dish, scanner, printer, wireless device, networking device, and the like. In some embodiments, the I/O components 320 can include the sensors 132 and controls 134 of the monitoring and control subsystem 128.

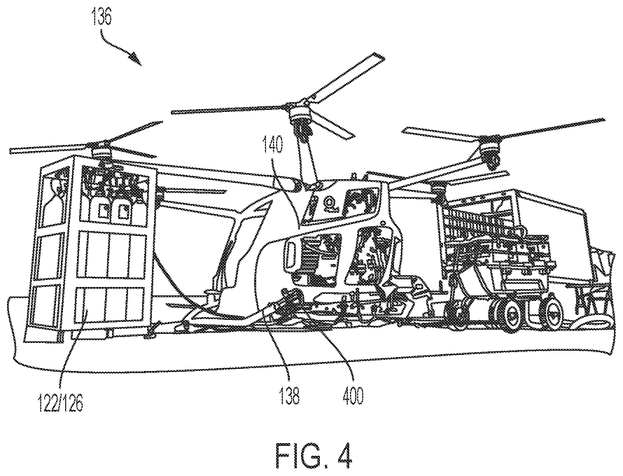

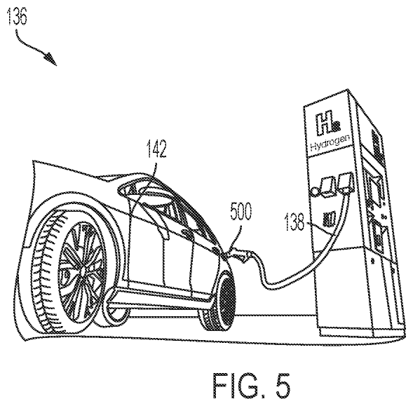

FIG. 4 and FIG. 5 depict an illustrative diagram of example embodiments of the present invention demonstrating dispensing subsystem 136 components that provide on-site refueling. A vehicle, such as a multirotor aircraft 140 in FIG. 4 or an automobile 142 in FIG. 5, can be driven or piloted to a designated area within the infrastructure location served by the system 100 and parked at the appropriate zone. A user and/or the vehicle then interfaces with the system (either a processor in the dispensing pump 138 of the processor 130 of the monitoring and control subsystem 128), inputting refueling information including refueling demand (fuel type, fuel quantity, etc.) and account information if required. Upon verification of a valid request, the dispensing pump 138 is instructed to proceed with refueling activities. A connection can be made to a refueling port of the vehicle 140/142 (e.g., by a connector 400/500 including a nozzle). A metered volume of fuel can be dispensed through the connector 400/500 into the refueling port and into the fuel tank of the vehicle 140/142, wherein the dispensing unit provides sensor data captured from the refueling flows that the monitoring and control subsystem 128 processes and adjusts dispensing based on the received data, ended dispensing when the requisite volume of fuel has been dispensed. Alternatively, a dispensing unit may be used to fill auxiliary tanks 210 on a delivery vehicle, such as a tanker 144 or multirotor aircraft 140 which is then piloted to a designated location where remote refueling occurs and the delivery vehicle 144/140 fills a fuel tank of a user vehicle, such as the multirotor aircraft 146 or automobile 148, at the designated location through a refueling port using the auxiliary tank 210 and connectors aboard the delivery vehicle.

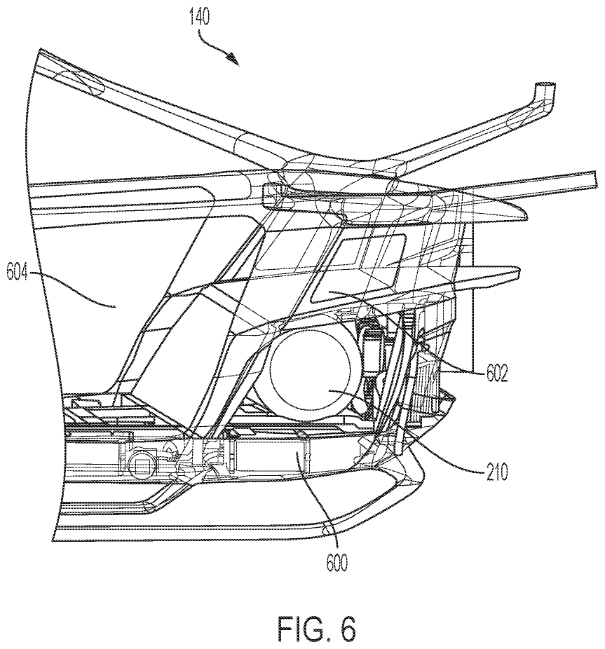

FIG. 6 is an example illustrative diagram of an auxiliary tank 210, located in a multirotor aircraft 140 adjacent to fuel cell modules 600 behind a firewall 602 separating the passenger compartment 604 from components.

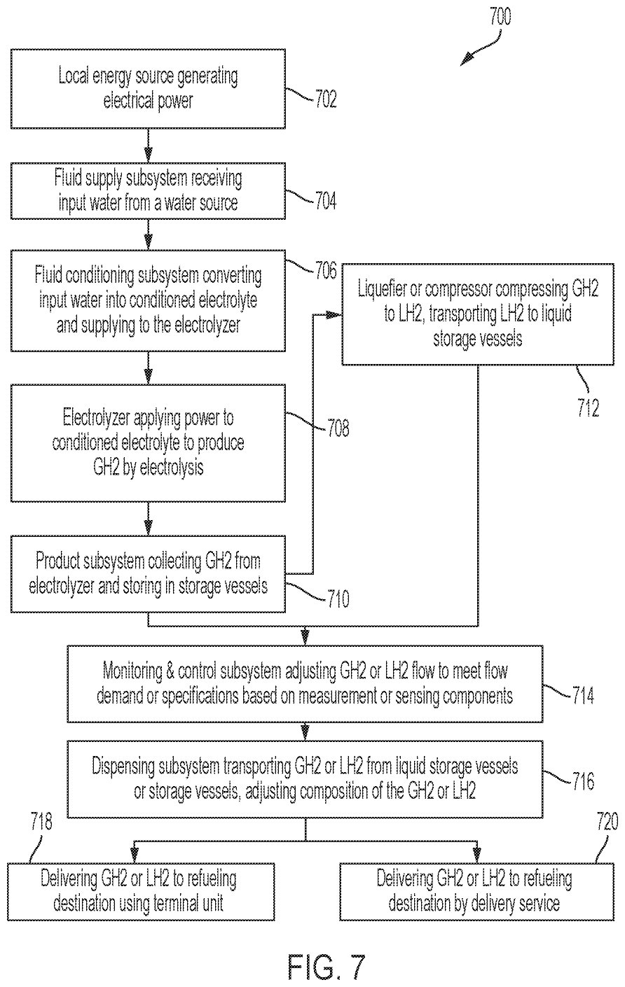

FIG. 7 depicts a flow chart that illustrates the present invention in accordance with one example embodiment showing a method 700 performed by the system 100 and apparatus. The method 700 comprises: at Step 702, a local energy source 102 generating power. At Step 704, a fluid supply subsystem 112 begins receiving input water from a water or fluid source 114. At Step 706, a fluid conditioning subsystem 116 converting input water into conditioned electrolyte and supplying that conditioned water to the electrolyzer 118. At Step 708, the electrolyzer 118 applies power to the conditioned electrolyte to produce GH₂ by electrolysis, wherein a PEM may be employed to initiate and govern the relevant reactions. At Step 710, a product subsystem 120 collects GH₂ from the electrolyzer 118, transporting the exit flow to one or more storage vessels 122. At Step 712, a portion of the exit flow directed by the product subsystem 120 may be diverted for additional processing including directing to a condenser or liquefier 124 that uses pressure to compress GH2 into a phase shift to LH₂, then storing LH₂ in separate liquid storage vessels 126. At Step 714, a monitoring and control subsystem 128 uses sensors 132 and controls 134 to perform several operations including adjusting GH₂ or LH2₂ flow to meet flow demand or system specifications based on measurement or sensing components that detect current operating conditions or characteristics in the system 100. At Step 716, fuel is selectively transported or supplied from the product subsystem 120 to a dispensing subsystem 136, adjusting the composition of the GH₂ or LH₂ where required to match demand. At Step 718, the components of the dispensing subsystem 136 deliver GH₂ or LH₂ to one or more refueling destinations, for example, to fill a fuel tank of a vehicle 140/142 parked in a refueling zone. At Step 720, delivering GH₂ or LH₂ to refueling destination may further be accomplished by fueling auxiliary tanks 210 of a transport vehicle including a tanker 144 or refueling clean-fuel multirotor aircraft 140 that then perform delivery service and dispense fuel to a designated vehicle 146/148 from the previously filled auxiliary tanks 210 at the appropriate designated location.

In certain embodiments, the controlling the production of GH₂ or LH₂ to meet demands (step 714 and 716) includes one or more of: increasing or decreasing flow of input water to the fluid supply subsystem 112; increasing or decreasing power generated from the local energy source 102; increasing or decreasing production and flow of conditioned electrolyte from the fluid conditioning subsystem 116 to the electrolyzer 118; increasing or decreasing a rate of electrolysis in the electrolyzer 118 producing gaseous hydrogen (GH2); increasing or decreasing flow of gaseous hydrogen GH2 from the electrolyzer 118 to one or more of: one or more storage vessels 122, and a liquefier or a compressor 124; increasing or decreasing flow of liquid hydrogen LH2, to one or more liquid storage vessels 126; increasing or decreasing flow of GH2 or LH2 from the one or more storage vessels 122 or one or more liquid storage vessels 126 to the dispensing subsystem 136; and increasing or decreasing flow of GH2 or LH2 to a refueling destination.

In some embodiments, the system 100 may be configured to function for energy collection and storage by being connected to an exterior electrical grid that supplies off-peak excess electrical voltage and current production capacity to the system 100 in order to convert that energy into hydrogen fuel that can be stored for later use or consumption, banking excess produced electrical energy/power. The system 100 may also be selectably, removably connected to an existing electrical grid for purposes of supplying electrical power to that grid or may be connected to a pipeline to supply hydrogen.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various parameters (sometimes referred to as requirements) are described which may be appropriate for some embodiments but not for other embodiments.

From the foregoing, it will be appreciated that, although specific embodiments of the technology have been described herein for purposes of illustration, various modifications may be made without deviating from the spirit and scope of the technology. Further, certain aspects of the new technology described in the context of particular embodiments may be combined or eliminated in other embodiments. Moreover, while advantages associated with certain embodiments of the technology have been described in the context of those embodiments, other embodiments may also exhibit such advantages, and not all embodiments need necessarily exhibit such advantages to fall within the scope of the technology. Also, contemplated herein are methods that may include any procedural step inherent in the structures and systems described. Accordingly, the disclosure and associated technology can encompass other embodiments not expressly shown or described herein.

The terms used in this specification generally have their ordinary meanings in the art, within the context of the disclosure, and in the specific context where each term is used. It will be appreciated that the same thing can be said in more than one way. Consequently, alternative language and synonyms may be used for any one or more of the terms discussed herein, and any special significance is not to be placed upon whether or not a term is elaborated or discussed herein. Synonyms for some terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification. Unless otherwise defined, all technical and scientific terms used herein have the same meaning as commonly understood by one of ordinary skill in the art to which this disclosure pertains. In the case of conflict, the present document, including definitions, will control.

To any extent utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about” and “approximately” are intended to cover variations that may existing in the upper and lower limits of the ranges of subjective or objective values, such as variations in properties, parameters, sizes, and dimensions. In one non-limiting example, the terms “about” and “approximately” mean at, or plus 10 percent or less, or minus 10 percent or less. In one non-limiting example, the terms “about” and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near-complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification, embodiments have been described in a way that enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A method of operating an off-grid variable-state hydrogen refueling infrastructure, the method comprising:
a local energy source generating electrical power;
a fluid supply subsystem receiving input water from a water source;
a fluid conditioning subsystem converting the input water into a conditioned electrolyte;
an electrolyzer applying generated electrical power to the conditioned electrolyte to produce gaseous hydrogen (GH₂) by electrolysis;
a product subsystem collecting the gaseous hydrogen (GH₂) and storing it in one or more storage vessels or converting the gaseous hydrogen (GH₂) into liquid hydrogen (LH₂) and storing the liquid hydrogen (LH₂) in one or more liquid storage vessels;
a monitoring and control subsystem dynamically controlling a production of gaseous hydrogen (GH₂) or liquid hydrogen (LH₂); and
a dispensing subsystem delivering the gaseous hydrogen (GH₂) or liquid hydrogen (LH₂) from storage vessels to one or more refueling destinations.

2. The method of claim 1, wherein the local energy source comprises one or more windmills or wind turbines, solar arrays, hydroelectric reservoirs or turbines, geothermal systems biomass reactors or digestors, tidal generators, nuclear generators, or natural gas processing unit or turbines.

3. The method of claim 1, wherein the water source of the fluid supply subsystem comprises one or more of a natural or man-made body of water, a municipal water supply, a water utility, a water treatment plant, a storm drainage system, an H2O pipeline, a precipitation storage reservoir or cistern, a water reclamation system, a well or ground water.

4. The method of claim 1, wherein the fluid supply subsystem converting the input water into conditioned electrolyte comprises treating the water source by adjusting salinity of the input water.

5. The method of claim 1, wherein converting gaseous hydrogen (GH₂) to liquid hydrogen (LH₂) is performed by a liquefier or specialized chiller or refrigerator.

6. The method of claim 1, wherein the monitoring and control subsystem comprises:
one or more sensors;
one or more production controls; and
at least one processor controlling the one or more production controls based on input from one or more sensors.

7. The method of claim 1, wherein the dispensing subsystem comprises one or more pump dispensers for delivering gaseous hydrogen (GH₂) or liquid hydrogen (LH₂).

8. The method of claim 1, wherein the refueling destination comprises a fuel tank of a clean-fuel electric vehicle stationed at a designated refueling zone serviced by the dispensing subsystem.

9. The method of claim 1, wherein the refueling destination comprises a tanker stationed at a designated refueling zone serviced by the dispensing subsystem.

10. The method of claim 9, wherein the tanker transports the gaseous hydrogen (GH₂) or liquid hydrogen (LH₂) to a clean-fuel electric vehicle stationed at a user location designated for remote refueling service.

11. The method of claim 9, wherein the tanker transports one or more modular, refillable GH2 or LH2 tanks that can be interchanged with an empty container at the refueling site.

12. The method of claim 1, wherein the refueling destination comprises an auxiliary fuel tank of a multirotor aircraft stationed at a designated refueling zone serviced by the dispensing subsystem.

13. The method of claim 12, wherein the multirotor aircraft transports the gaseous hydrogen (GH₂) or liquid hydrogen (LH₂) to a clean-fuel electric vehicle stationed at a user location designated for remote refueling service.

14. The method of claim 1, wherein the one or more storage vessels or one or more liquid storage vessels comprise one or more of insulated tanks, compressed gas tanks, mobile tanks, cryogenic tanks, or tanker trucks.

15. The method of claim 1, wherein the electrolyzer is a polymer electrolyte membrane (PEM) electrolysis.

16. The method of claim 1, wherein, dynamically controlling production of gaseous hydrogen (GH₂) or liquid hydrogen (LH₂) comprises one or more of:
increasing or decreasing flow of input water to the fluid supply subsystem;
increasing or decreasing power generated from the local energy source;
increasing or decreasing production and flow of conditioned electrolyte from the fluid conditioning subsystem to the electrolyzer;
increasing or decreasing a rate of electrolysis in the electrolyzer producing gaseous hydrogen (GH2);
increasing or decreasing flow of gaseous hydrogen GH2 from the electrolyzer to one or more of: one or more storage vessels, a liquefier, or a compressor;
increasing or decreasing flow of liquid hydrogen LH2, to one or more liquid storage vessels;
increasing or decreasing flow of GH2 or LH2 from the one or more storage vessels or one or more liquid storage vessels to the dispensing subsystem; and
increasing or decreasing flow of GH2 or LH2 to a refueling destination.

17. The method of claim 1, further comprising a selectably activated alternative connection to an electrical grid configured to supply selectively off-peak excess grid electricity for conversion into LH2 or GH2 that is stored for later consumption using the one or more storage vessels or one or more liquid storage vessels.

18. An off-grid variable-state hydrogen refueling system infrastructure, the system infrastructure comprising:
a local energy source generating electrical power;
a fluid supply subsystem receiving input water from a water source;
a fluid conditioning subsystem, in fluid communication with the fluid supply subsystem, configured to convert the input water into a conditioned electrolyte;
an electrolyzer, in electrical communication with the local energy source and fluid communication with the fluid conditioning subsystem, configured to apply generated electrical power to the conditioned electrolyte to produce gaseous hydrogen (GH₂) by electrolysis;
a product subsystem, in fluid communication with the electrolyzer, configured to collect the gaseous hydrogen (GH₂) and store it in one or more storage vessels or convert the gaseous hydrogen (GH₂) into liquid hydrogen (LH₂) and store the liquid hydrogen (LH₂) in one or more liquid storage vessels;
a monitoring and control subsystem configured dynamically controlling a production of gaseous hydrogen (GH₂) or liquid hydrogen (LH₂); and
a dispensing subsystem, in fluid communication with the product subsystem, configured to deliver the gaseous hydrogen (GH₂) or liquid hydrogen (LH₂) from storage containers to one or more refueling destinations.

19. The system of claim 18, wherein the local energy source comprises one or more windmills or wind turbines, solar arrays, hydroelectric reservoirs or turbines, geothermal systems biomass reactors or digestors, tidal generators, nuclear generators, or natural gas processing unit or turbines.

20. The system of claim 18, wherein the water source of the fluid supply subsystem comprises one or more of a natural or man-made body of water, a municipal water supply, a water utility, a water treatment plant, a storm drainage system, an H2O pipeline, a precipitation storage reservoir or cistern, a water reclamation system, a well or ground water.

21. The system of claim 18, wherein the fluid supply subsystem converts the input water into conditioned electrolyte by treating the water source by adjusting salinity of the input water.

22. The system of claim 18, wherein converting gaseous hydrogen (GH₂) to liquid hydrogen (LH₂) is performed by a liquefier or specialized chiller of refrigerator.

23. The system of claim 18, wherein the monitoring and control subsystem comprises:
one or more sensors;
one or more production controls; and
at least one processor controlling the one or more production controls based on input from one or more sensors.

24. The system of claim 18, wherein the dispensing subsystem comprises one or more pump dispensers for delivering gaseous hydrogen (GH₂) or liquid hydrogen (LH₂).

25. The system of claim 18, wherein the refueling destination comprises a fuel tank of a clean-fuel electric vehicle stationed at a designated refueling zone serviced by the dispensing subsystem.

26. The system of claim 18, wherein the refueling destination comprises a tanker stationed at a designated refueling zone serviced by the dispensing subsystem.

27. The system of claim 26, wherein the tanker transports the gaseous hydrogen (GH₂) or liquid hydrogen (LH₂) to a clean-fuel electric vehicle stationed at a user location designated for remote refueling service.

28. The system of claim 18, wherein the refueling destination comprises an auxiliary fuel tank of a multirotor aircraft stationed at a designated refueling zone serviced by the dispensing subsystem.

29. The system of claim 28, wherein the multirotor aircraft transports the gaseous hydrogen (GH₂) or liquid hydrogen (LH₂) to a clean-fuel electric vehicle stationed at a user location designated for remote refueling service.

30. The system of claim 18, wherein the one or more storage vessels or one or more liquid storage vessels comprise on or more of insulated tanks, compressed gas tanks, mobile tanks, cryogenic tanks or tanker trucks.

31. The system of claim 18, wherein the electrolyzer is a polymer electrolyte membrane (PEM) electrolysis.

32. The system of claim 18, wherein, dynamically controlling production of gaseous hydrogen (GH₂) or liquid hydrogen (LH₂) comprises one or more of:
increasing or decreasing flow of input water to the fluid supply subsystem;
increasing or decreasing power generated from the local energy source;
increasing or decreasing production and flow of conditioned electrolyte from the fluid conditioning subsystem to the electrolyzer;
increasing or decreasing a rate of electrolysis in the electrolyzer producing gaseous hydrogen (GH2);
increasing or decreasing flow of gaseous hydrogen GH2 from the electrolyzer to one or more of: one or more storage vessels, a liquefier, or a compressor;
increasing or decreasing flow of liquid hydrogen LH2, to one or more liquid storage vessels;
increasing or decreasing flow of GH2 or LH2 from the one or more storage vessels or one or more liquid storage vessels to the dispensing subsystem; and
increasing or decreasing flow of GH2 or LH2 to a refueling destination.

33. The system of claim 18, further comprising a selectably activated alternative connection to an electrical grid configured to supply selectively off-peak excess grid electricity for conversion into LH2 or GH2 that is stored for later consumption using the one or more storage vessels or one or more liquid storage vessels.
